(19) United States
(12) Patent Application Publication
(10) Pub. No.: US 2023/0334505 A1
(43) Pub. Date: Oct. 19, 2023

(54) PROCESSING OF CUSTOMER MESSAGES TO AVOID UNNECCESSARY FRAUD DISPUTES

(71) Applicant: Capital One Services, LLC, McLean, VA (US)

(72) Inventors: Abdelkader M'Hamed BENKREIRA, Washington, DC (US); Michael MOSSOBA, Great Falls, VA (US); Joshua EDWARDS, Philadelphia, PA (US)

(73) Assignee: Capital One Services, LLC, McLean, VA (US)

(21) Appl. No.: 17/724,244

(22) Filed: Apr. 19, 2022

(51) Int. Cl. G06Q 30/00

(52) U.S. Cl. CPC G06Q 30/016

(57) ABSTRACT

The exemplary embodiments may assist in determining whether a fraud dispute for a payment card transaction is valid or not. The exemplary embodiments enable an agent to access and scan customer messages to attempt to locate messages relating to a payment card transaction in dispute. The exemplary embodiments may process messages such as email messages, instant messages, text messages and the like. The agent may gain remote access to at least some of the customer messages and scan the messages. The scanned content may then be parsed and programmatically processed to locate any messages that are likely relevant to the payment card transaction that is in dispute. For example, the exemplary embodiments may look at messages and attempt to locate any messages that are order confirmation messages, shipping messages or the like for the payment card transaction.

### BACKGROUND

For payment card accounts, like credit card accounts, customers submit a sizeable number of fraud disputes regarding transactions listed on billing statements to the associated financial institutions. The fraud disputes allege that the charges shown on a customer's billing statement are fraudulent or in error. A portion of the fraud disputes submitted by customers prove to be truly illegitimate. However, a great number of the fraud disputes prove to be invalid disputes that challenge legitimate charges. Unfortunately, for many of the disputed charges, the reason for the disputes is that the customers often do not remember payment card transactions that they authorized. In other instances, the disputes are prompted by the billing statement information provided to the customers for the payment card transactions being unrecognizable to the customers as the information is not complete, does not clearly identify what was purchased and/or lists a different entity than that recognized by the customers as vendors for the transactions.

As it is difficult to prove that a disputed payment card transaction is valid, in many instances, the payment card issuer will absorb the cost of the transaction to engender good will with the customer even though the disputed payment card transaction likely is legitimate. Often, the payment card issuer cancels the old payment card and issues a new payment card in response to such a disputed payment card transaction. Hence, the aggregate costs associated with such disputed payment card transactions that are legitimate may be significant.

### SUMMARY

In accordance with a first inventive aspect, a non-transitory computer-readable storage medium is provided that stores programming instructions for execution by a processor. The programming instructions cause the processor to identify a set of messages to be searched among emails received by a customer in a date range where the date range is based at least in part on a date of a payment card transaction of the customer that is in dispute. The programming instructions also cause the processor to search the set of messages to locate either a message evidencing that the payment card transaction was completed or a message evidencing that a product was shipped to the customer as a result of the payment card transaction. The programming instructions further cause the processor to, where the searching locates either a message evidencing that the payment card transaction was completed or a message evidencing that a product was shipped to the customer as a result of the payment card transaction, notify the customer of the located message.

The non-transitory computer-readable storage medium may additionally store programming instructions for execution by a processor to receive permission from the customer to remotely access the messages received by the customer. The searching may be realized via a web browser extension. The non-transitory computer-readable storage medium may additionally store programming instructions for execution by a processor to notify the customer that neither a message evidencing that the payment card transaction was completed nor a message evidencing that a product was shipped to the customer as a result of the payment card transaction were located. The searching with the processor of the set of messages may include scanning content of the set of messages and parsing the scanned content into tokens. The searching with the processor of the set of messages may further include comparing the tokens with one or more vendor names for the payment card transaction to locate any matches. The searching with the processor of the set of messages may further include concluding that a selected message in the set of messages is a message evidencing that the payment card transaction was completed has been located where one or more of the tokens for the selected message matches the one or more vendor names for the payment card transaction. The searching with the processor of the set of messages may include comparing the tokens with one or more shipping merchant names to locate any matches. The searching with the processor of the set of messages may include concluding that a selected message in the set of messages is a message evidencing that a product was shipped to the customer as a result of the payment card transaction where one or more of the tokens for the selected message matches the one or more one or more shipping merchant names for the payment card transaction.

In accordance with another inventive aspect, a method is performed by a processor of a computing device. The method includes receiving a communication of an indication of a transaction dispute from a customer of a payment card transaction and responsive to the receiving, remotely accessing with the processor emails received by a customer of a payment card transaction and searching with the processor for a message that contains a receipt relating to the payment card transaction in the remotely accessed messages received by the customer. The method further entails, where a selected message that contains a receipt relating to the payment card transaction is found in the remotely accessed messages received by the customer, notifying the customer of the selected message by sending a notification to the customer.

The searching may include searching for a vendor name for the payment card transaction in the remotely accessed messages received by the customer. The searching may include searching for a shipping merchant name for the payment card transaction in the remotely accessed messages received by the customer. The searching may include searching for a dollar amount that matches that of the payment card transaction in the remotely accessed messages received by the customer. The searching may search messages in an inbox of a message account of the customer. The searching may, in some embodiments, only search messages received by the customer having time stamps indicating that the messages were received after the payment card transaction. Where a selected message that contains a receipt relating to the payment card transaction is not found in the remotely accessed messages received by the customer, the customer may be notified that no message containing a receipt was found. The notification may contain content from the selected message or contains a reference for the user to access the selected message.

In accordance with another inventive aspect, a computing device includes a non-transitory computer-readable storage medium storing programming instructions and a processor configured for executing the programming instructions to cause the processor to remotely access messages received by a customer of a payment card transaction, search for a message that contains a receipt relating to the payment card transaction in the remotely accessed messages received by the customer, and, where a selected message that contains a receipt relating to the payment card transaction is found in the remotely accessed messages received by the customer, notify the customer of the selected message by sending a notification to the customer.

The non-transitory computer-readable storage medium additionally may store a web browser and a remote access web browser extension and wherein the processor is configured for executing the web browser and the remote access web browser extension to perform the remotely accessing of the messages received by the customer of the payment card transaction. The non-transitory computer-readable storage medium additionally may store programming instructions for an open authorization protocol and wherein the processor is configured for executing the programming instructions for the open authorization protocol to perform the remotely accessing of the messages received by the customer of the payment card transaction.

### BRIEF DESCRIPTION OF THE DRAWINGS

FIG. 1 depicts an illustrative environment for exemplary embodiments.

FIG. 2 depicts an illustrative customer computing device for an exemplary embodiment.

FIG. 3A depicts an illustrative agent computing device for an exemplary embodiment.

FIG. 3B depicts illustrative components of an agent support application in an exemplary embodiment.

FIG. 4A depicts a flowchart of illustrative steps that may be performed in exemplary embodiments for resolving a fraud dispute from a customer.

FIG. 4B depicts an illustrative user interface of an exemplary embodiment for requesting permission to access the messages of a customer.

FIG. 5A depicts a flowchart of illustrative steps that may be performed in exemplary embodiments to process customer messages.

FIG. 5B depicts a diagram of illustrative actions that may be taken in exemplary embodiments responsive to no message being found in processing customer messages.

FIG. 5C depicts a diagram of illustrative actions that may be taken in exemplary embodiments responsive to a message being found in processing customer messages.

FIG. 6 depicts a flowchart of illustrative steps that may be performed in exemplary embodiments to iteratively process messages.

FIG. 7A depicts a flowchart of illustrative steps that may be performed in exemplary embodiments to process a single message.

FIG. 7B depicts illustrative rules that may be applied in exemplary embodiments.

FIG. 8A depicts an example of an order confirmation email from a vendor.

FIG. 8B depicts an example of a delivery confirmation email from a shipping merchant.

FIG. 9 depicts a flowchart of illustrative steps that may be performed to apply a machine learning model to customer emails to identify a relevant message regarding a disputed transaction.

### DETAILED DESCRIPTION

The exemplary embodiments may assist in determining whether a fraud dispute for a payment card transaction is valid or not. The exemplary embodiments enable an agent to access and scan customer messages to attempt to locate messages relating to a payment card transaction that is in dispute. The exemplary embodiments may process messages such as email messages, instant messages, text messages and the like. The agent may gain remote access to at least some of the customer messages and scan the messages. The scanned content may then be parsed and programmatically processed to locate any messages relating to the payment card transaction that is in dispute. For example, the exemplary embodiments may look at messages and attempt to locate any messages that are order confirmation messages, shipping messages or the like for the payment card transaction.

The located messages may refresh the customer's memory of the payment card transaction. The located messages may also provide additional information that supplements the limited information contained in a billing statement entry for the customer to clarify what payment card transaction the disputed billing statement entry is referencing. As a result, customers may withdraw their disputes if the disputes are not warranted in view of the located messages. This may result in a substantial reduction in fraud disputes that are fully pursued by customers and heighten customers' confidence in the legitimacy of the entries in their billing statements.

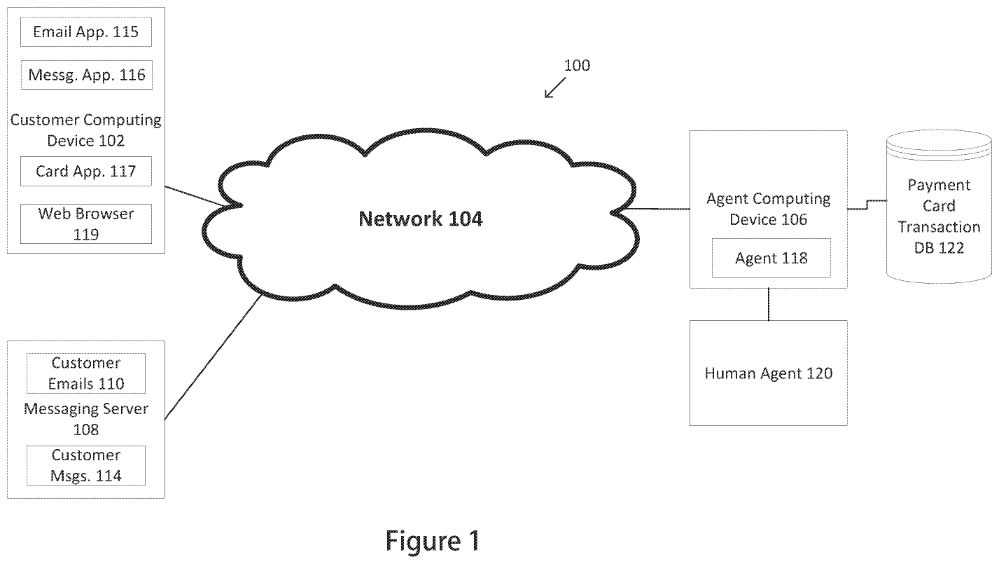

FIG. 1 depicts a computing environment 100 suitable for some exemplary embodiments. The computing environment 100 includes a customer computing device 102 that is accessible by a customer and an agent computing device 106 that is accessible by an agent acting on behalf of a financial organization or other organization that issued the customer a payment card. Both the customer computing device 102 and the agent computing device 106 are connected to network 104. Network 104 may encompass a local area network (LAN), a wide area network (WAN), such as the Internet or a combination thereof. Network 104 may include a cellular network, a WiFi network or another type of wireless network. Network 104 also may include wired networks.

The customer computing device 102 may be a smart phone, a tablet computer, a laptop computer, a desktop computer, a smartwatch or other type of computing device. The customer computing device 102 may include an email application 115 for supporting the use of email on the customer computing device 102. The customer computing device 102 may include one or more messaging applications 116, such as instant messaging applications, short message service (SMS) applications, and/or other types of messaging applications, such as the Instagram messaging application, the WhatsApp messaging application, the Messenger messaging application and the like. The customer computing device 102 also may include a card application 117 that supports functionality associated with a payment card issued by an issuer. The card application 117 may be an application provided by a financial institution, like a bank. The customer computing device 102, in addition, may include a web browser 119 for accessing web sites and displaying web pages from web sites.

A messaging server 108 may be provided for supporting a messaging service that is used by the customer on the customer computing device 102. The messaging server 108 may provide support for messaging services and may store customer emails 110 associated with a customer's mailboxes (e.g., inbox, sent box, etc.). The messaging server 108 may store customer messages 114 that are not emails as well. The customer messages 114 may include, for instance SMS messages, and other types of messages.

The agent computing device 106 may be a smart phone, smart watch, a tablet computer, a laptop computer, a desktop computer, a server computer or other suitable type of computing device. The agent computing device 106 may be used by a human agent 120. The agent computing device 106 may include a programmable intelligent agent 118 that is implemented in software. The programmable intelligent agent 118 may perform much of the functionality described below for locating and processing messages in exemplary embodiments. The agent computing device 106 may have access to a payment card transaction database 122 holding information regarding payment card transactions of card holders for a card issuer.

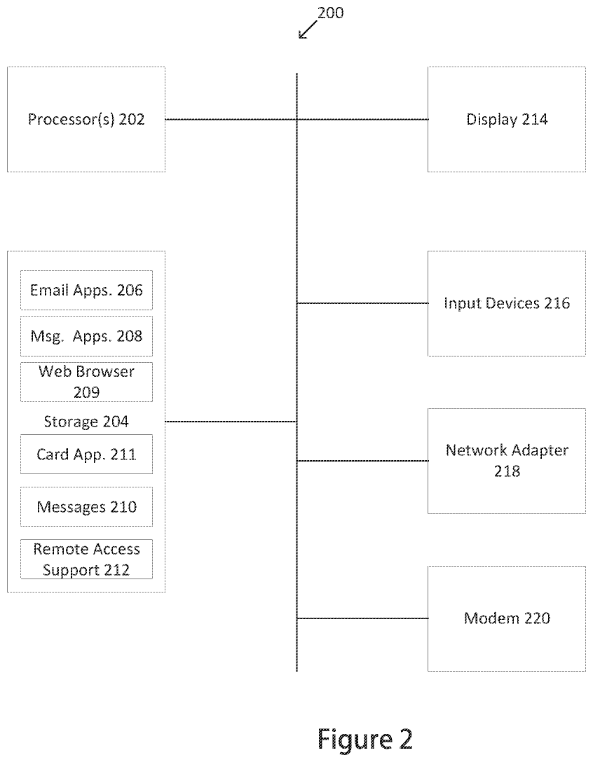

FIG. 2 depicts an illustrative customer computing device 200 in additional detail. The customer computing device 200 may include one or more processors 202. The one or more processors 202 may include multi-core processors. The one or more processors 202 may be microprocessors, field programmable gate arrays (FPGAs), graphics processing units (GPUs), application specific integrated circuits (ASICs), or the like. The one or more processors may execute programming instructions stored in the storage 204.

The storage 204 may include primary memory, secondary memory or a combination thereof. The storage 204 may include random access memory (RAM) in its various forms and well a read only memory (ROM) in its various forms. The storage may include flash memory, magnetic storage, optical storage, etc. The storage 204 may store email applications 206 for sending, receiving and storing email, messaging applications 208 for sending, receiving and storing messages, such as an SMS application and other varieties of messaging applications, as mentioned above. The storage 204 may store a web browser 209 and a card application 211. The storage 204 may store copies of at least some messages 210 locally on the customer computing device 200. The storage 204 may also store remote access support 212, such as support for enabling remote access to the customer computing device 200 by the agent computing device 106. The remote access support 212 may include, for example, support for an OAuth that authorizes remote access and support for enabling remote access via a web browser extension.

The customer computing device 200 may also include a display 214 for displaying graphical, textual and video content. The customer computing device 200 also may include a number of input devices 216, such as a keyboard, a mouse, a thumbpad, a microphone or a touchscreen display. The customer computing device 200 may include a network adapter 218 to connect with the network 104. The customer computing device 200 may include a modem 220 for connection to a cellular network or cable network that is part of network 104.

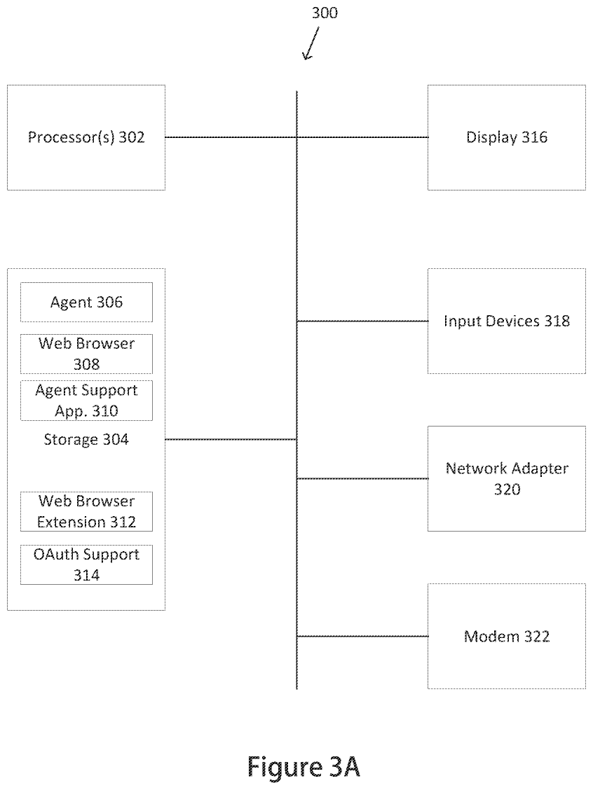

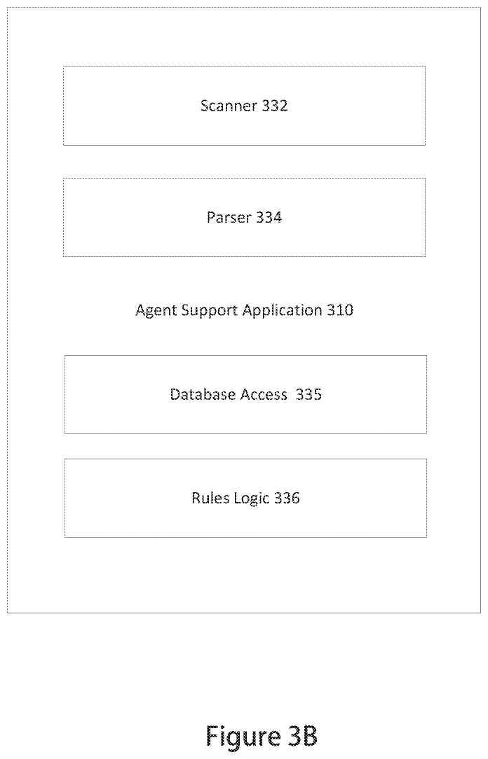

FIG. 3A depicts an illustrative agent computing device 300. The agent computing device 300 may include one or more processors 302. The one or more processors 302 may include multi-core processors. The one or more processors 302 may be microprocessors, FPGAs, GPUs, ASICs, or the like. The one or more processors may execute programming instructions stored in the storage 304. The storage 304 may include the programmatic intelligent agent 306 and a web browser 308.

The storage 304 also may store an agent support application 310. This agent support application 310 may include instructions for providing support for the agent, whether the agent is a human agent 120 or the programmable intelligent agent 306 than runs on the one or more processors 302. FIG. 3B depicts various illustrative components of the agent support application 310. The agent support application 310 may include a scanner 332 for scanning content of customer messages. The agent support application 310 also may include a parser 334 for parsing the scanned content into tokens and rules logic 336 for applying rules relating to the parsed tokens to determine whether a message is relevant or not to the disputed payment card transaction. The rules logic 336 may be realized in software that applies rules encoded in software to each message to determine if the message likely is relevant or not. The agent support application 310 further may include a module or instructions for facilitating database access to the payment card transaction database 122.

The storage 304 (FIG. 3A) may include a web browser extension 312 that facilitates remote access to the customer computing device 102. Examples of such a web browser extension include but are not limited to the Chrome Remote Desktop from Google LLC, TeamViewer Remote Desktop from TeamViewer AG, or Zoho Assist Free Remote from Zoho Corporation. The storage 304 may instead include OAuth support 314 for open access delegation, such as per the OAuth 2.0 standard for open delegation established by the Internet Engineering Task Force (IETF). The OAuth 2.0 standard enables an access token to be issued to a third-party client by an authorization server, with the approval of the resource owner. The third party then uses the access token to access the protected resources hosted by the resource server. The access token is limited to being valid for a short period of time, such as 5 minutes.

The agent computing device 300 may also include a display 316 for displaying graphical, textual and/or video content. The agent computing device 300 may include input devices 318, such as a keyboard, mouse, a thumbpad, a microphone or a touchscreen display. The agent computing device 300 may include a network adapter 320 to connect with the network 104. The agent computing device 300 may include a modem 322 for connection to a cellular network or cable network that is part of network 104.

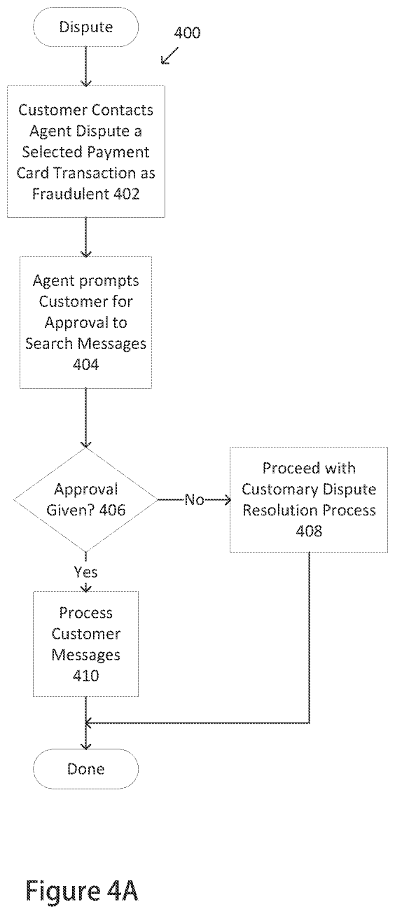

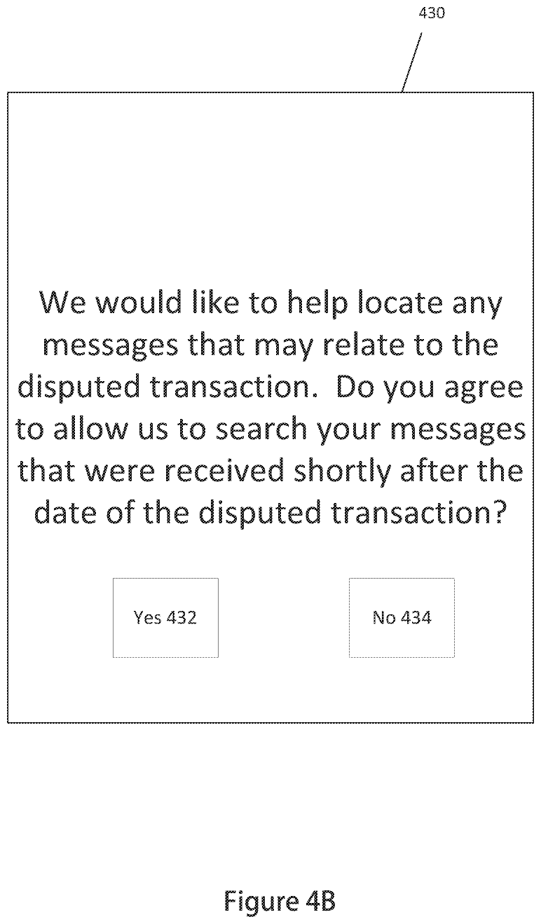

As mentioned above, the exemplary embodiments may provide a way to remotely process the customer's messages and identify which messages contain content that may be relevant to a disputed payment card transaction. FIG. 4A depicts a flowchart 400 of illustrative steps that may be performed in exemplary embodiments with respect to a dispute raised by a customer with respect to a payment card transaction. Initially, the customer contacts the agent regarding a selected payment card transaction that is detailed in a billing statement to dispute the transaction as fraudulent at 402. The customer may contact the agent using the card application 115. The card application 115 may include a chat feature or may include a user interface that enables the customer to contact an agent. The agent may be a human agent 120 or the programmatic intelligent agent 118. The customer may also contact the agent 118, 120 via website for the card issuing organization using the web browser 209 or even by phone if the agent is a human agent 120.

At 404, the agent 118, 120 may prompt the customer for permission to remotely access a subset of the messages of the customer. This may be done over the phone by a human agent 120 or done via a user interface prompt seeking permission. FIG. 4B depicts an example user interface prompt 430. If the customer wishes to have their messages processed the customer may select the “yes” button 432. If not, the customer selects the “No” button 434. If approval is not given as checked at 406, the agent 118, 120 proceeds with the customary dispute resolution process for the card issuer at 408. However, if permission is granted as checked at 406, the customer messages are processed to identify any messages relating to the transaction in dispute at 410.

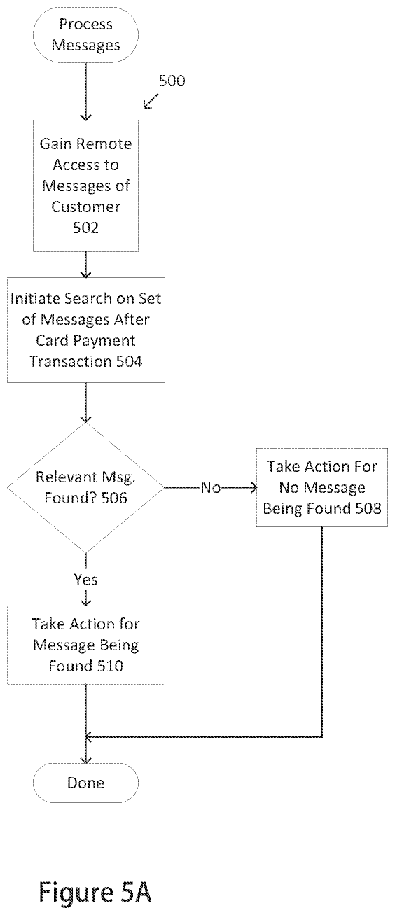

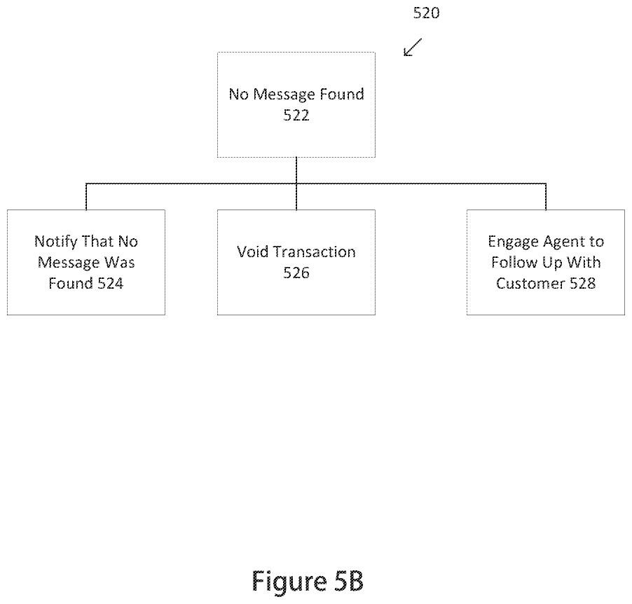

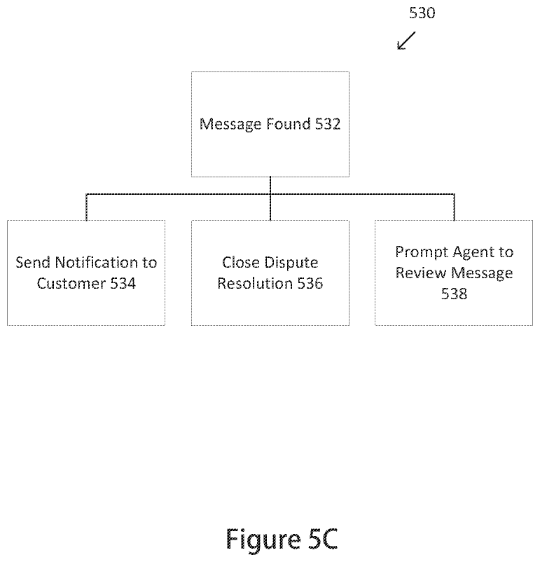

FIG. 5A depicts a flowchart 500 of illustrative steps that may be performed by software running on the agent computing device 106 (such as the agent support application 310, agent 306, web browser extension 312, OAuth support 314 and/or web browser 308) to process the messages once permission is granted. At 502, remote access to the messages of the customer is gained using remote access mechanisms such as an OAuth or a remote access web extension. The messages that are accessed may be messages 210 stored on the customer computing device 102 and/or messages 114 stored on the messaging server 108. At 504, a search is initiated on a set of messages that were received by the customer after the payment card transaction. The search selects messages and processes the messages to see if the messages are relevant to the disputed payment card transaction. The search may process messages in a particular time window, such as within 5 days, 30 days or 90 days, after the dispute payment card transaction took place. The notion behind the time windows is that the time windows correspond to the time frame in which an order confirmation and/or delivery related message is likely to be received by the customer. The variability in the time windows relates to the nature of the goods/services that were purchased. For example, a book purchased online using a payment card may be likely to be delivered within 5 days, whereas a larger item may require a 30-day delivery window and some items, like furniture may require a 90-day delivery window. It may be up to the agent 118, 120 to define the time window or the transaction may be encoded on the agent side to have an associated time window.

Once the search is initiated, at 506, a check is made of whether any relevant messages have been found. A relevant message is one that contains information that is likely to contain information relating to the disputed payment card transaction. If no relevant messages are found, a number of actions may be taken at 508. FIG. 5B depicts a diagram 520 of illustrative actions that may be taken in some exemplary embodiments when no message is found 522. One action that may be taken at 524 is to send a notification that no relevant messages have been found to the customer. This may entail sending a message from the programmatic intelligent agent 118 to the customer, displaying the notification on a user interface of the card application 115 or a website for the payment card issuer. Another option at 526 is to void the transaction since there is no proof of the transaction being entered into by the customer. A further option, at 528, is to have the agent 118, 120 seek to gather additional information from the customer or to otherwise engage with the customer to decide whether to void the transaction or not. Multiple ones of these actions may be taken together. Moreover, other actions not shown may also be taken in some embodiments. After these actions the dispute resolution process may continue to proceed, such as discussed above regarding step 408.

If, however, a relevant message is found, at 510, one or more actions may be taken. FIG. 5C depicts a diagram 530 of some of the actions that may be taken in exemplary embodiments responsive to a determination that no message was found 532. A first action, at 534, is for a notification that one or more relevant messages was found to be sent to the user via a message or via a user interface of the web browser or card application 115. A second possible action, at 536, is to close the dispute resolution process responsive to the message being found. A third option, at 538, is to prompt the agent to review the message. The user and agent 118, 120 may review the content of the relevant messages and ask the customer if the customer wishes to continue with the dispute resolution process or if instead, the customer wishes to withdraw the dispute. If the relevant messages evidence the payment transaction, the notification should dissuade the customer from proceeding with the dispute. These actions may be performed together in some instances. Moreover, different actions may be taken. These actions are intended to be illustrative and not limiting.

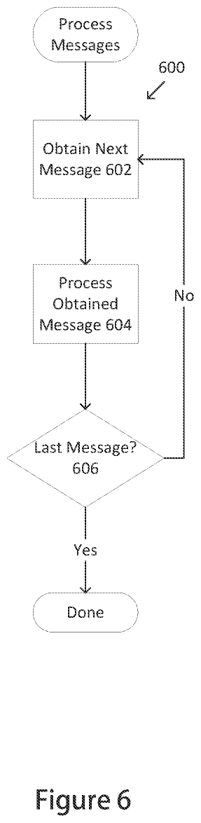

The search of step 504 entails multiple retrieved messages within the specified time window. FIG. 6 depicts a flowchart of illustrative steps that may be performed in exemplary embodiments on the retrieved messages. The messages are processed individually. At 602, the next message among the messages is obtained. At 604, the obtained message is processed to review its content to determine if the obtained message is relevant as will be described below. At 606, a check is performed to determine whether the obtained message is the last message to be processed. If not, the process repeats beginning at step 602. Otherwise, the process terminates.

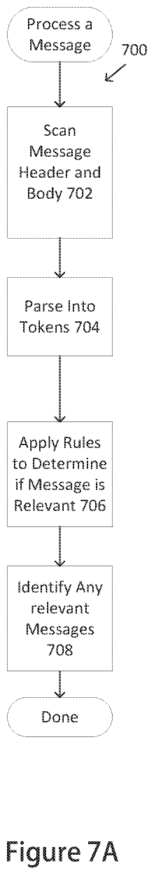

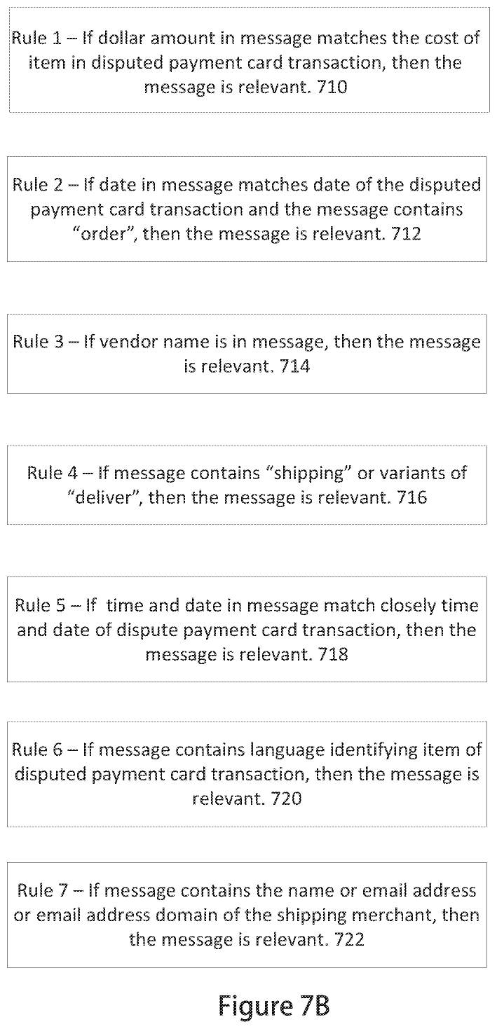

FIG. 7A depicts a flowchart 700 of illustrative steps that may be performed to process an individual message. At 702, the message header and body are scanned. The scanning obtains the content of the header and body so that content may be further processed. At 704, a parser parses the scanned content into tokens. A token is a subset of characters in a string of characters, such as a word, an email address, a string of characters delimited by spaces, a punctuation mark, that has meaning. The parser contains knowledge of a grammar and how to chop the string into tokens based on the grammar. At 706, the rules logic 336 is applied to determine if, based on the analysis of the tokens and possibly other meta data like timestamps, the rules indicate that the message is likely relevant to the disputed payment card transaction.

The rules logic 336 applies to the content and meta data of the message. FIG. 7B depicts an example of some illustrative rules that may be applied. This depiction is illustrative and not intended to exhaustive or limiting.

As can be seen Rule 1 (710), recites that if a dollar amount found in a message matches the cost of an item in the disputed payment card transaction, then the message is relevant. For example, if the disputed payment card transaction was for a football that cost $55.00 and “$55.00” is found in the message, then the message is likely relevant.

Rule 2 (712) is that if a date in the message matches the date of the disputed payment card transaction and the message contains the token “order”, then the message is relevant. The idea behind this rule is that the presence of “order” in the message likely means that the message relates to an order, and if the dates match, then the message likely is relevant.

Rule 3 (714) is that if the message contains the vendor's name, then the message is relevant. Any message in the search time window that mentions the vendor is likely relevant.

Rule 4 (716) is that if a message contains “shipping” or variants of “delivery”, then the message is likely relevant. The presence of such terms indicate that the message is likely a shipping or delivery confirmation and hence, indicate that the message is likely relevant.

Rule 5 (718) is that is the time and date closely match the time and date of the disputed payment card transaction, then the message is likely relevant. More often than not, order confirmations are generated within minutes of the payment card transaction. Thus, for example, the rule may require that the message be generated within 5 minutes of the date and time of the disputed payment card transaction.

Rule 6 (720) is that if the message contains language identifying the item in the disputed payment card transaction, then the message is likely relevant. For instance, if the disputed payment card transaction was for the purchase of a leather football, the presence of “football” or “leather” may imply that the message likely is relevant.

Rule 7 (722) is that if the message contains the shipping merchant name or address (or address domain), then the message is likely relevant. The rule is based on the notion that an email from the shipping merchant in the searched time window is likely to be relevant.

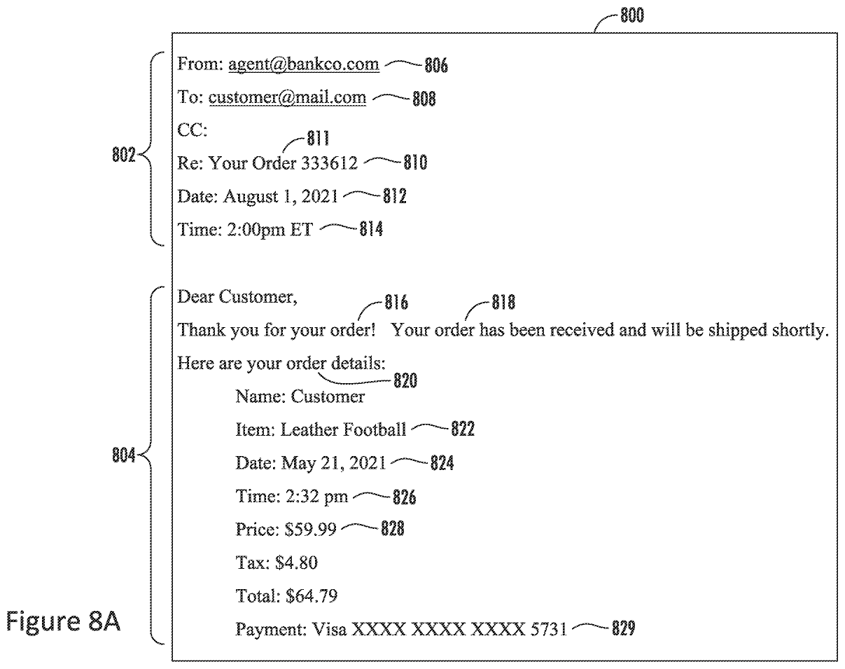

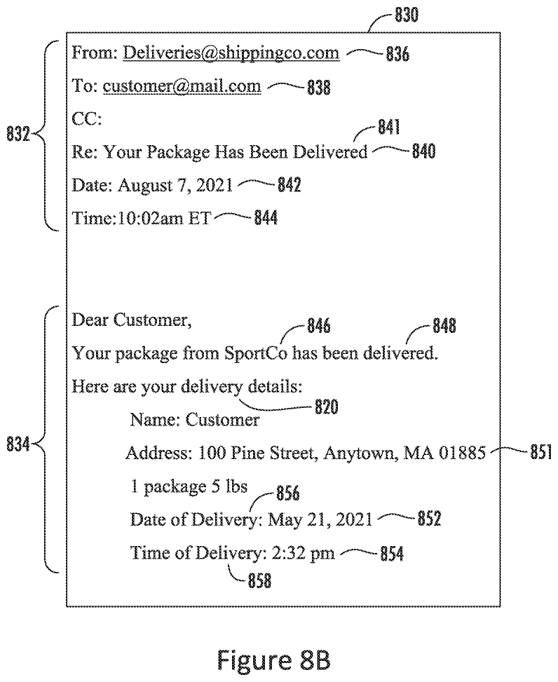

FIG. 8A depicts an example email message to a customer that helps illustrate how a message is processed. As discussed above, at 702, the content of the message is scanned. As shown in FIG. 8A, content of the header 802 and the body 804 are scanned. At 704, the content is parsed. The header includes a “From” line 806 containing the email address of the sender, and line 808 contains the email address of the recipient of the email. The reference line 810 specifies an order number. The “Date” line 812 specifies the date the email was received and the “Time” line 814 specifies the date that the email was received. The header content is parsed into tokens. In this example, the email address of the sender at line 806 may be a token relevant to a rule as the “bankco.com” email address domain may be indicative of a vendor. The rules logic 336 may access the payment card transaction database 122 in applying the rules to obtain information regarding the disputed payment card transaction. The token “Order” in the reference line 810 may be relevant to a rule as indicating that the email is an order confirmation. The order number “333612” may be relevant to a rule as well and can be compared to the order number of the disputed payment card transaction to see if there is a match. The date and time are relevant to a rule as order confirmations are usually sent out within a few hours of the payment card transaction.

The content of the body 804 of the email 800 is also parsed at 704 and matched with target items at 706. Tokens such as “order” 816, 818 and 820 may be relevant to a rule. The presence of “order” may be indicative of the email 800 confirming an order. The tokens “leather” and “football” at line 822 may be relevant to a rule as they may match a description of an item purchased in the disputed payment card transaction. Likewise, the date on line 824 and the time on line 826 may be relevant to a rule as they may match or be sufficiently close to the date and time on record for the payment card transaction. The price “$59.99” on line 828 may be relevant to a rule. The price may be compared to the price of the item purchased in the disputed payment card transaction to determine if the email 800 likely is relevant. The credit card number on line 829 may be relevant to a rule as the last four digits, which are visible, may be compared with those of the payment card for the customer to determine if the email 800 likely is relevant.

FIG. 8B depicts an illustrative shipping email 830. The shipping email contains content from the header 832 and content from the body 834. The content from the header 832 includes a “From” line 836 identifying the sender of the email and a “To” line 838 identifying the recipient. The email address in the “From” line 836 may be relevant to a rule and may match one of known email addresses for shipping merchants. The header content 832 includes a reference line 840. The token “delivered” in the reference line may match a target item. The date line 842 and time line 844 are included in the header content 832. The content in the body 834 of the shipping email is also processed. The token “SportsCo” 846 may be relevant to a rule as it is the identity of the vendor. This token may be compared with the target item of the vendor name for the disputed payment card transaction. The token “delivered” 848 and the tokens “delivery” 850, 856 and 858 may be relevant to a rule because they may indicate that the item was delivered and may indicate that the email 830 is a delivery confirmation email. The address 851 may be relevant to a rule and may be matched to the customer. The date of delivery 856 and the time of delivery 858 may be matched to the delivery records for the item purchased in the disputed payment card transaction.

The processing of the customer messages need not be performed by a ruled based approach. Instead, a machine learning model may be used to identify relevant messages among the customers messages. The intelligent agent 118 may include a machine learning model, such as a neural network model, a decision tree network model, or a random forest model. Consider the case of the machine learning model is a neural network model. In that case, the neural network model may employ nodes as basic units of computation. Each node may receive inputs from other nodes or from an external source and compute an output. Each input is weighted to indicate the relative importance of the input to the other inputs. The weights applied to the inputs are learnable and control the strength of influence. The inputs may be summed at the node, and if the sum exceeds a threshold, the node may fire to generate an output. An activation function determines when the node fires. The activation function may be, for example, a sigmoid function that produces a value between 0 and 1. Another alternative is a tanh function that produces values in the range between −1 and +1.

The neural network model may include several layers. These layers may include an input layer of input nodes that pass inputs on to the next layer in the neural network model. The layers may include a hidden layer that performs computation using the inputs from the input layer. Outputs from nodes of the hidden layer may be passed to another hidden layer or to an output layer. The output layer has nodes that produce outputs, such as probabilities. The neural network model may include a learning rule which modifies the weights and thresholds of the neural network model in order for the inputs to produce a favored output. An example of a learning rule is a delta rule. The delta rule compares how far an output answer from the neural network model is from the actual answer and makes adjustments to the connection weights to decrease the error. The delta rule relies upon backwards error propagation of weight adjustments. The backwards propagation performs a gradient descent toward a global minimum in the solution space.

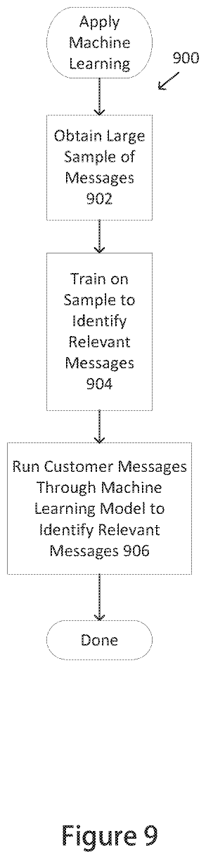

FIG. 9 depicts a flowchart 900 of illustrative steps that may be performed to apply a machine learning model to customer emails to identify a relevant message regarding a disputed transaction. At 902, a large sample of messages is obtained. The large sample may be used to train the machine learning model to identify what customer messages are relevant to a disputed transaction at 904. The sample should include relevant and irrelevant messages and should include a large number of messages. The training enables the machine learning model to identify the context and characteristics of relevant messages. After the machine learning model is fully trained, at 906, the machine learning model may be applied to a customer message set by an agent 118, 120, to identify any relevant messages.

While exemplary embodiments have been described herein, it should be appreciated that various changes in form and detail may be made without departing from the scope of the appended claims.

1. A non-transitory computer-readable storage medium storing programming instructions for execution by a processor to cause the processor to:
identify a set of messages to be searched among messages received by a customer in a date range, the date range being based at least in part on a date of a payment card transaction of the customer that is in dispute;
search the set of messages to locate either:
a message evidencing that the payment card transaction was completed, or
a message evidencing that a product was shipped to the customer as a result of the payment card transaction; and
where the searching locates either a message evidencing that the payment card transaction was completed or a message evidencing that a product was shipped to the customer as a result of the payment card transaction, notify the customer of the located message.

2. The non-transitory computer-readable storage medium of claim 1, wherein the non-transitory computer-readable storage medium additionally stores programming instructions for execution by a processor to cause the processor to receive permission from the customer to remotely access the messages received by the customer.

3. The non-transitory computer-readable storage medium of claim 2, wherein the searching is realized via a web browser extension.

4. The non-transitory computer-readable storage medium of claim 1, wherein the non-transitory computer-readable storage medium additionally stores programming instructions for execution by a processor to cause the processor to notify that customer that neither a message evidencing that the payment card transaction was completed nor a message evidencing that a product was shipped to the customer as a result of the payment card transaction were located.

5. The non-transitory computer-readable storage medium of claim 1, wherein the searching with the processor the set of messages comprises:
scanning content of the set of messages; and
parsing the scanned content into tokens.

6. The non-transitory computer-readable storage medium of claim 5, wherein the searching with the processor the set of messages further comprises comparing the tokens with one or more vendor names for the payment card transaction to locate any matches.

7. The non-transitory computer-readable storage medium of claim 6, wherein the searching with the processor of the set of messages further comprises concluding that a selected message in the set of messages is a message evidencing that the payment card transaction was completed has been located where one or more of the tokens for the selected message matches the one or more vendor names for the payment card transaction.

8. The non-transitory computer-readable storage medium of claim 5, wherein the searching with the processor the set of messages further comprises comparing the tokens with one or more shipping merchant names to locate any matches.

9. The non-transitory computer-readable storage medium of claim 8, wherein the searching with the processor of the set of messages further comprises concluding that a selected message in the set of messages is a message evidencing that a product was shipped to the customer as a result of the payment card transaction where one or more of the tokens for the selected message matches the one or more one or more shipping merchant names for the payment card transaction.

10. A method performed by a processor of a computing device, comprising:
receiving a communication of an indication of a transaction dispute from a customer of a payment card transaction;
response to the receiving, remotely accessing with the processor messages received by the customer of the payment card transaction;
searching with the processor for a message that contains a receipt relating to the payment card transaction in the remotely accessed messages received by the customer; and
where a selected message that contains a receipt relating to the payment card transaction is found in the remotely accessed messages received by the customer, notifying the customer of the selected message by sending a notification to the customer.

11. The method of claim 10, wherein the searching comprises searching for a vendor name for the payment card transaction in the remotely accessed messages received by the customer.

12. The method of claim 10, wherein the searching comprises searching for a shipping merchant name for the payment card transaction in the remotely accessed messages received by the customer.

13. The method of claim 10, wherein the searching comprises searching for a dollar amount that matches that of the payment card transaction in the remotely accessed messages received by the customer.

14. The method of claim 10, wherein the searching searches messages in an inbox of a message account of the customer.

15. The method of claim 10, wherein the searching only searches messages received by the customer having time stamps indicating that the messages were received after the payment card transaction.

16. The method of claim 10, wherein the method further comprises, where a selected message that contains a receipt relating to the payment card transaction is not found in the remotely accessed messages received by the customer, notifying the customer that no message containing a receipt was found.

17. The method of claim 10, wherein the notification contains content from the selected message or contains a reference for the user to access the selected message.

18. A computing device, comprising:
a non-transitory computer-readable storage medium storing programming instructions;
a processor configured for executing the programming instructions to cause the processor to:
remotely access messages received by a customer of a payment card transaction;
search for a message that contains a receipt relating to the payment card transaction in the remotely accessed messages received by the customer; and
where a selected message that contains a receipt relating to the payment card transaction is found in the remotely accessed messages received by the customer, notify the customer of the selected message by sending a notification to the customer.

19. The computing device of claim 18, wherein the non-transitory computer-readable storage medium additionally stores a web browser and a remote access web browser extension and wherein the processor is configured for executing the web browser and the remote access web browser extension to perform the remotely accessing of the messages received by the customer of the payment card transaction.

20. The computing device of claim 18, wherein the non-transitory computer-readable storage medium additionally stores programming instructions for an open authorization protocol and wherein the processor is configured for executing the programming instructions for the open authorization protocol to perform the remotely accessing of the messages received by the customer of the payment card transaction.
